(19) United States
(12) Patent Application Publication
(10) Pub. No.: US 2008/0052982 A1
(43) Pub. Date: Mar. 6, 2008

(54) Wood-Boring Insect Trap

(76) Inventor: Earl S. Windsor, Ellijay, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/846,766

(22) Filed: Aug. 29, 2007

Related U.S. Application Data
(60) Provisional application No. 60/841,248, filed on Aug. 30, 2006.

(51) Int. Cl. A01M 1/14; A01M 1/20

(52) U.S. Cl. 43/114; 43/107

(57) ABSTRACT

Apparatus, methods, and systems provide for the trapping and disablement of wood-boring insects such as carpenter bees. According to various embodiments described herein, a wood-boring insect trap includes a trap body, at least one longitudinal passage, and at least one insect entryway. The longitudinal passage is positioned within the trap body so that it is exposed when the wood-boring insect trap is not installed on a structure to be protected and enclosed when the trap is installed on the structure. The entryway intersects the longitudinal passage and allows wood-boring insects to enter the trap, proceed to the passage, where the insect will encounter an insect disabling substance. According to embodiments, the insect disabling substance may be a poison, glue, or a combination thereof.

### CROSS REFERENCE TO RELATED APPLICATIONS

The present application claims priority under 35 U.S.C. §119 to co-pending U.S. provisional application No. 60/841,248 entitled “Carpenter Bee Trap” filed on Aug. 30, 2006, which is expressly incorporated in its entirety herein by reference.

### BACKGROUND

In North America, and in other parts of the world, certain flying insects can damage wood structures by boring through the wood to nest. Carpenter bees, for example, are known to bore into wood structures, and can drill tunnels ten to twelve inches long in a year. Carpenter bees are typically of the family Xylocopa, and in North America are primarily comprised of the species Xylocopa virginica. Over the course of many years, as carpenter bees continue to use the same nest, bored tunnels can reach six feet or more in length. Multiple tunnels may eventually weaken a wood structure. In addition, the sawdust and exterior holes created may be unsightly.

FIG. 1A depicts an example of carpenter bee damage 102 to an exposed rafter 104 of a wooden structure 100. FIG. 1B depicts a detailed view of the rafter 104 and the carpenter bee damage 102. Here, the carpenter bee damage 102 consists of an external opening 106 in the rafter 104 and an internal tunnel 108 extending from the opening 106 through an interior portion of the rafter 104. The tunnel 108 consists of a first tunnel portion 108a and a second tunnel portion 108b. The first tunnel portion 108a may represent the extent of the carpenter bee damage 102 after a first year of occupying the rafter 104. After a second year of use, the second tunnel portion 108b may result as an extension of the first tunnel portion 108a. Eventually, structural damage to the wooden structure 100 may result, especially if multiple tunnels 108 are created in close proximity to one another. The tunnel 108 is angled, primarily because carpenter bees may prefer to angle the tunnel 108 so that sawdust and debris created during construction and nesting will be removed from the tunnel 108 with the assistance of gravity.

Among the available preventatives for carpenter bee damage is the use of a thick coat of paint or some other wood treatment. However, these sometimes do not prevent infestation, due to thin spots, or to determined insects. Once a nest is established, carpenter bees may keep coming back to the same nests year after year. Poisons and wood fillers can be used to kill a nest and fill in the holes, but these are not always the safest or most effective forms of treatment.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to embodiments presented herein, apparatus, methods, and systems provide for the trapping and disablement of wood-boring insects such as carpenter bees. According to various embodiments, a wood-boring insect trap includes a trap body, at least one longitudinal passage, and at least one insect entryway. The longitudinal passage is positioned within the trap body so that it is exposed when the wood-boring insect trap is not installed on a structure to be protected and enclosed when the trap is installed on the structure. The entryway intersects the longitudinal passage and allows wood-boring insects to enter the trap, and to proceed to the passage.

Embodiments provide for a wood-boring insect trap system that includes an insect disabling substance applied to a surface of the longitudinal passage. The disabling substance may include a poison, a glue or other binding agent, or a combination thereof. A method for creating the wood-boring insect trap according to various embodiments include creating the longitudinal passage in the trap body by fabricating a channel within a rear surface of the trap body that is mounted against a surface of the structure to be protected. In this manner, the channel is exposed for application of an insect disabling substance when the wood-boring insect trap is not installed on the structure to be protected, but concealed to create the longitudinal passage when the wood-boring insect trap is installed on the structure. Entryways for the insects are created that extend from either a side surface or front surface of the wood-boring insect trap to the longitudinal passage.

Other apparatus, systems, and/or methods according to embodiments will be or become apparent to one with skill in the art upon review of the following drawings and Detailed Description. It is intended that all such additional apparatus, systems, and/or methods be included within this description, be within the scope of the present invention, and be protected by the accompanying claims.

### BRIEF DESCRIPTION OF THE DRAWINGS

FIG. 1A is a pictorial diagram showing a perspective view of typical carpenter bee damage in a wooden structure;

FIG. 1B is a pictorial diagram showing an enlarged view of the carpenter bee damage to the wooden structure shown in FIG. 1A;

FIG. 2 is a pictorial diagram showing a perspective view of a wood-boring insect trap according to one embodiment presented herein;

FIGS. 3A-3C are pictorial diagrams showing rear, side, and rear perspective views, respectively, of the wood-boring insect trap according to the embodiment shown in FIG. 2;

FIG. 4 is a pictorial diagram showing a perspective view of a wood-boring insect trap according to another embodiment presented herein;

FIGS. 5A-5D are pictorial diagrams showing rear, top, cross-sectional, and rear perspective views respectively of the wood-boring insect trap according to the embodiment shown in FIG. 4; and

FIG. 6 is a flow diagram illustrating a method for creating a wood-boring insect trap according to one embodiment presented herein.

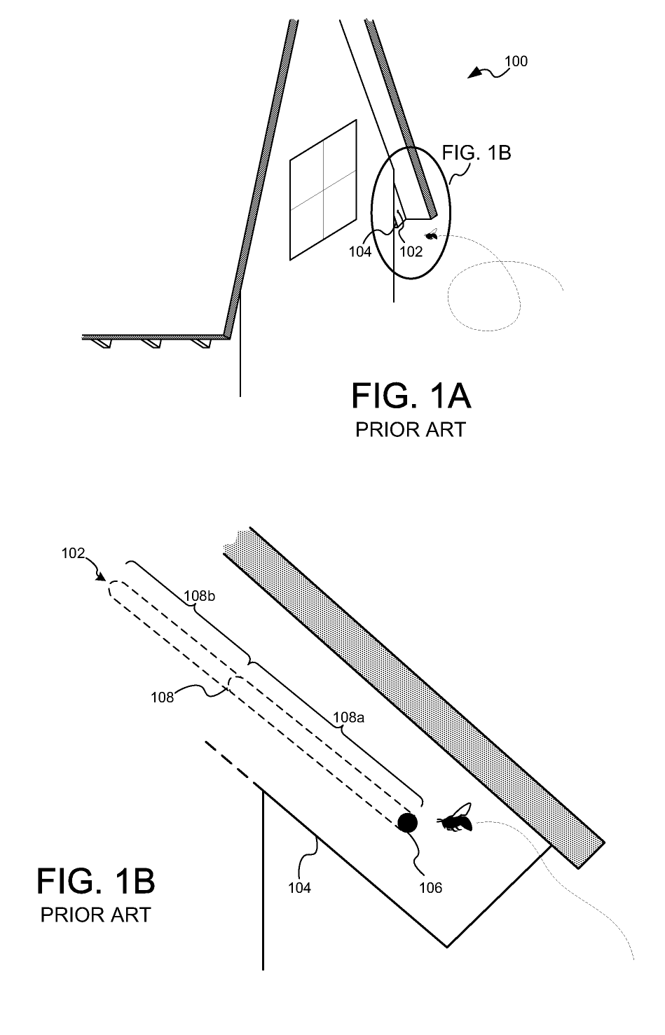

### DETAILED DESCRIPTION

The following detailed description is directed to an apparatus, method, and system for preventing wood-boring insect damage. In the following detailed description, references are made to the accompanying drawings that form a part hereof, and which are shown, by way of illustration, using specific embodiments or examples. Referring now to the drawings, in which like numerals represent like elements through the several figures, aspects of the apparatus provided herein will be described. Throughout this disclosure, embodiments are discussed with respect to trapping carpenter bees. However, it should be appreciated that the described embodiments are equally applicable to any type of wood-boring insect and is not limited to use with carpenter bees. The dimensions of the devices described below, as well as the quantities and dimensions of any openings or channels within the disclosed devices may be altered to target a specific wood-boring insect.

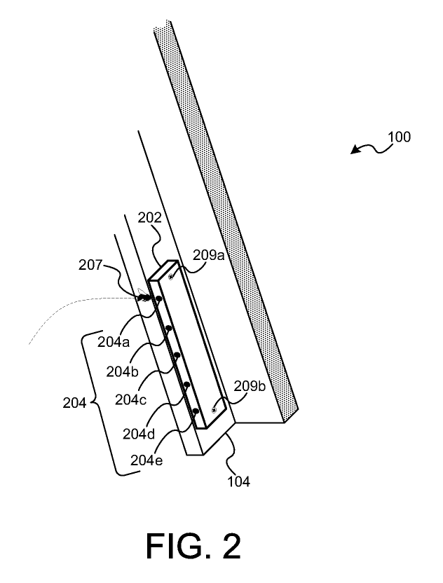

FIG. 2 depicts an example of a carpenter bee trap 202 as it may be utilized to trap carpenter bees and prevent the bees from damaging the wooden structure 100. The wooden structure 100 may include a house or other building, a deck, a tower, or any other structure having any exterior surface made of wood. The carpenter bee trap 202 may be affixed to the exterior of the wooden structure 100. The carpenter bee trap 202 may be comprised of cedar, redwood, fir, spruce, pine, cypress, and/or any other soft wood preferred by adult carpenter bees. It should be noted that the carpenter bee trap 202 need not necessarily be created of wood. However, if the surfaces surrounding the entryways 204 are wooden, this may serve to attract the insects. The carpenter bee trap 202 may be painted or otherwise treated in order to camouflage or advertise the trap's presence, or may include exposed wood in an effort to attract more carpenter bees. The carpenter bee trap 202 may be affixed to the wooden structure 100 using screws 209a and 209b. Other methods for affixing the trap to the structure may be utilized, including the use of VELCRO, or nails. It is useful to use a method of affixing which allows easy removal of the carpenter bee trap 202 so that captured insects can be disposed of.

The carpenter bee trap 202 includes the entryways 204. Here, the carpenter bee trap 202 includes five entryways 204a-204e, but other quantities may be used. According to one embodiment, the entryways 204 may be located along a narrow longitudinal surface of the carpenter bee trap 202. The entryways 204 may be drilled at an angle perpendicular to the longitudinal axis of the carpenter bee trap 202, where the longitudinal axis may be situated at an upward angle, so as to approximate how a carpenter bee constructs its own nest. The angle of an entryway 204 relative to the longitudinal axis need not necessarily be perpendicular, and other angles may suffice. A carpenter bee 207 is attracted to the exposed entryway 204a, which is due to a preference of such insects to use existing holes and nests, a preference for exposed and/or untreated or unpainted wood, and/or a preference for an attractant rubbed on the entryway 204a or located proximate the entryway 204a. Upon entry, the carpenter bee 207 may be immobilized, poisoned, or otherwise disabled, thereby preventing future damage to wooden structure 100 by the carpenter bee 207. The interior structure of the carpenter bee trap 202 may include additional holes, tunnels, devices, and substances so as to assist in luring and disabling the carpenter bee 207, as will be described in greater detail below.

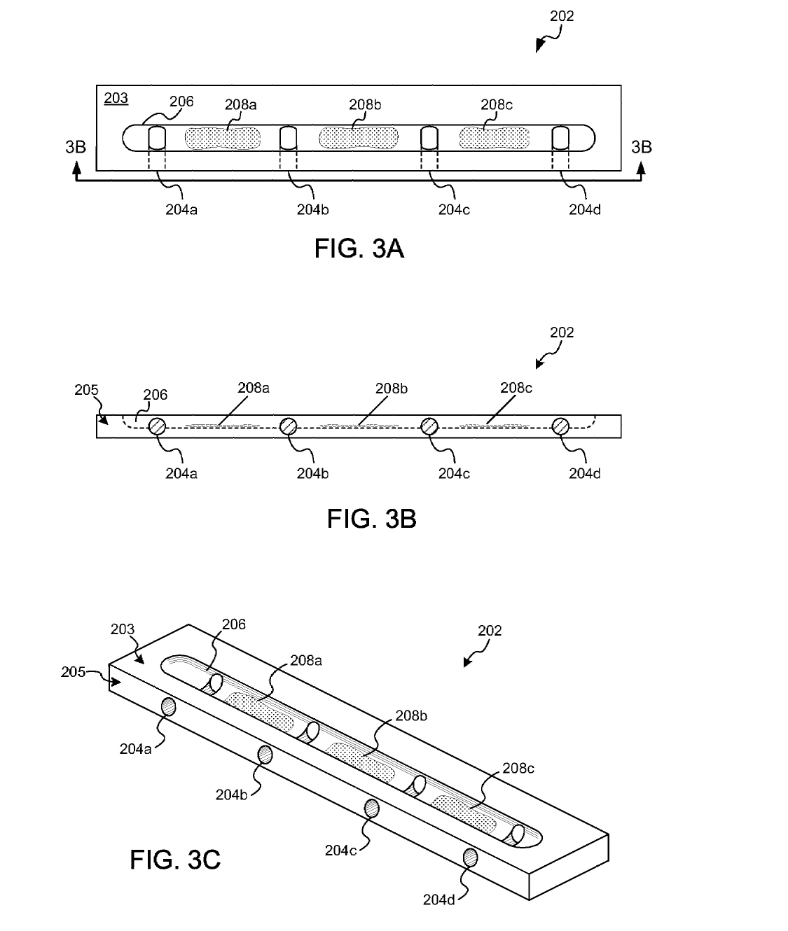

FIGS. 3A-3C depict rear, side, and rear perspective views, respectively, of the uninstalled carpenter bee trap 202 that is shown installed on the rafter 104 in FIG. 2. The rear surface 203 of the carpenter bee trap 202 abuts the rafter 104 of the wooden structure 100 when the carpenter bee trap 202 is installed. According to one embodiment, the side surface 205 of the carpenter bee trap 202 includes four entryways 204a-204d. As stated above, any number of entryways 204 may be included in the side surface 205 of the carpenter bee trap 202 without departing from the scope of this disclosure.

The entryways 204a-204d, intersect a longitudinal passage 206. The longitudinal passage 206 runs parallel to the longitudinal axis of the carpenter bee trap 202. The longitudinal passage 206 may be a groove or routed passage that is open when the carpenter bee trap 202 is not installed, as shown in FIGS. 3A-3C. Having an open longitudinal passage 206 allows for ease of access for cleaning and for applying the disabling substance 208. When the carpenter bee trap 202 is installed, the rear surface 203 of the carpenter bee trap 202 abuts a surface of the rafter 104, enclosing the longitudinal passage 206. Alternatively, the longitudinal passage 206 may be enclosed using a method other than affixing surface to the wooden structure 100. For example, the longitudinal passage 206 may be enclosed using a cover or a symmetrical hinged block. As stated above, the entryways 204 intersect the longitudinal passage 206, creating a pathway that approximates the nest of the carpenter bee 207. Although depicted using the single longitudinal passage 206, it should be appreciated that any number of longitudinal passages 206 may be utilized. The entryways 204 may be spaced apart at any distance, regular or irregular. However, each entryway 204 should have at least enough clearance between at least one other hole to allow placement of the disabling substance 208.

The disabling substance 208 may be placed in the interior of the longitudinal passage 206. The disabling substance 208 may be placed at any location between the entryways 204. The disabling substance 208 may be a form of poison, preferably without an odor that would deter the advancing carpenter bee 207. The disabling substance 208 may also be a form of insect glue, which is sticky enough to prevent further movement by the carpenter bee 207 when crawling over it. If insect glue is utilized as the disabling substance 208, it should be made not to dry and should retain its sticking qualities over a period of time, such as months or years. Combinations of disabling substances 208 may be available, such as, for example, insect glue that includes a poison. In addition to poison or insect glue, the disabling substance 208 may also be comprised of other substances that disable or kill an encroaching insect.

When placing the disabling substance 208, there may need to be a set back from the intersection of the entryway 204 and the longitudinal passage 206. By keeping the disabling substance 208 away from the entryway 204, the approaching carpenter bee 207 will more likely turn the corner and come into contact with the disabling substance 208, ultimately being immobilized, injured, killed, or otherwise disabled. A set back of approximately one inch may be necessary to ensnare the carpenter bee 207, but any amount of set back may be used. It should be understood that although FIGS. 3A-3C show the disabling substance 208 disposed between each adjacent entryway 204, the disabling substance may be placed in a single location or at any number of locations within the longitudinal passage 206.

The longitudinal passage 206 may be any shape or width, so long as the body of the carpenter bee 207 or other targeted insect can freely negotiate the passage. Here, the longitudinal passage 206 may be a concave channel that is three-quarters (¾) of one inch wide and one-half (⅜) inch deep and may be created using a router or other wood working tool. The entryways 204 similarly may be any shape or width, so long as the body of the carpenter bee 207 can pass through. For example, the entryways 204 may vary between three-eighths (⅜) and five-eighths (⅝) of an inch in diameter. Here, the entryways 204 may be circular and be one-half (½) inch in diameter. The entryway 204 may be any depth before encountering an intersection with the longitudinal passage 206, especially a depth that approximates an actual carpenter bee nest. Here, the depth of the entryway 204 is approximately five-eighths (⅝) of an inch. The entryways 204 may be spaced apart any distance from each other, allowing for room for the disabling substance 208. Here, the entryways 204 vary between four and seven inches apart. The wood or structure utilized to create the carpenter bee trap 202 may be any thickness that accommodates the entryways 204 and the longitudinal passage 206. The wood here is approximately three-quarters (¾) of an inch thick.

As described above, when the rear surface 203 of the carpenter bee trap 202 is affixed to a structure, the longitudinal passage 206 becomes an enclosed tunnel. The approaching carpenter bee 207 may enter through entryway 204 and proceed towards longitudinal passage 206. At the intersection, the carpenter bee 207 may believe that it is in a nest and enter the longitudinal passage 206 towards the disabling substance 208. Once coming into contact with the disabling substance 208, the carpenter bee 207 may be disabled, stuck, injured, and/or killed. Subsequent carpenter bees 207 may enter the same or other entryways 204 and be disabled themselves. It may be necessary to provide multiple entryways 204 to accommodate multiple carpenter bees 207, although one may be sufficient.

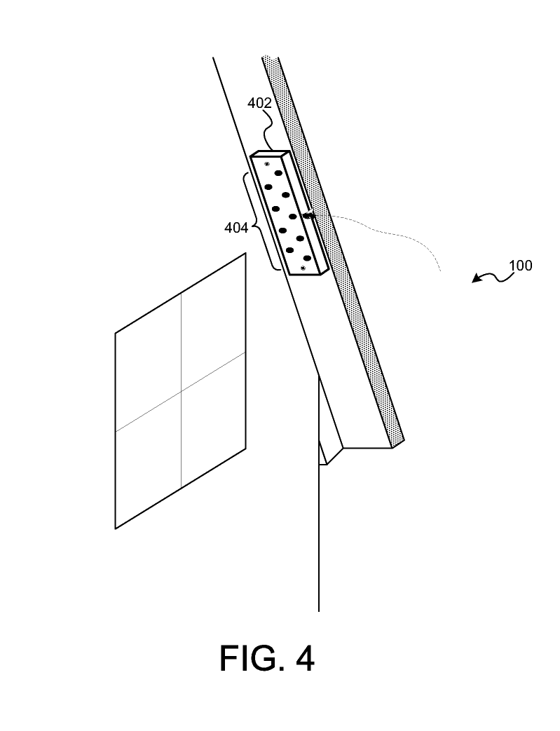

Turning now to FIG. 4, a carpenter bee trap 402 according to an alternative embodiment will be described. The carpenter bee trap 402 includes multiple entryways 404. The entryways 404 are located along a wider longitudinal surface, and are again drilled in a direction mostly perpendicular to the longitudinal axis of the carpenter bee trap 402. Here, the carpenter bee trap 402 is affixed along the underside of a surface of the wooden structure 100, although the carpenter bee trap may be placed on a vertical surface of the wooden structure 100 as well. The specific location for placement need not be specific, but the location should be exterior to the structure and able to be sensed by the insects. Locating the carpenter bee trap 402 near existing carpenter bee damage may be an attractive location. Again, the longitudinal axis of the carpenter bee trap 402 is oriented at an upward angle.

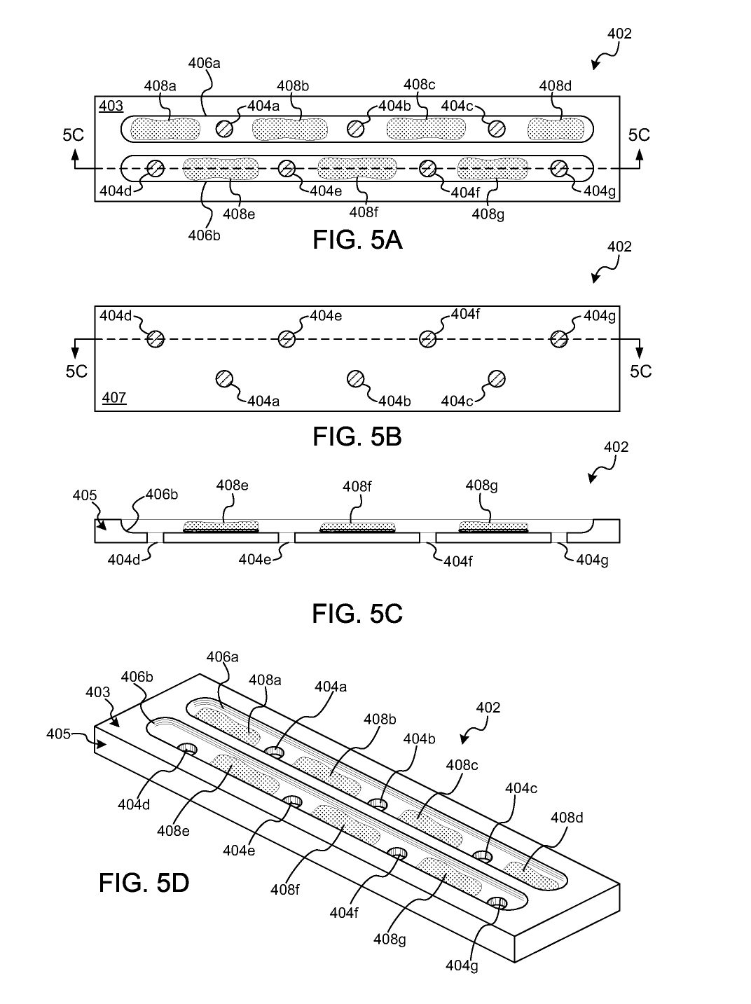

FIGS. 5A-5D depict rear, top, cross-sectional, and rear perspective views, respectively, of the carpenter bee trap 402 according to the embodiment shown in FIG. 4. As with the carpenter bee trap 202 of FIGS. 2-3C, the carpenter bee trap 402 is affixed to the wooden structure 100 such that the rear surface 403 of the carpenter bee trap 402 abuts the rafter 104 of the wooden structure 100 when the carpenter bee trap 402 is installed. Longitudinal passages 406, including longitudinal passages 406a and 406b, run parallel to the longitudinal axis of the carpenter bee trap 402. Entryways 404, rather than entering through a narrow side such as side surface 205 of the carpenter bee trap 202 shown in FIG. 3B, enter through the top surface 407 of the carpenter bee trap 402, which is wide surface opposite the rear surface 403 that abuts the wooden structure 100. As before, the entryways 404a-404g intersect with the longitudinal passages 406a and 406b, creating a 90-degree path for carpenter bees to follow. In between the entryways 404 and along the longitudinal passages 406, a disabling substance 408 has again been placed, allowing for a set back from each of the entryways 404. The entryways 404 may extend any to any depth before intersecting the longitudinal passages 406. Here, the entryways 404 extend approximately one-quarter (¼) inch into the carpenter bee trap 402.

It should be appreciated that the carpenter bee traps 202 and 402 may be installed and removed as needed. They can be left up year-round, or merely during the season when carpenter bees 207 create their nests (i.e. the springtime). The carpenter bee traps 202 and 402 may need to be removed periodically in order to remove disabled carpenter bees 207. The length of each carpenter bee trap 202 and 402 is not essential to the disclosure herein, although thirty (30) inches in length may be used. The width of each carpenter bee trap 202 and 402 is also not essential to the disclosure herein, although a width of three and one-half (3½) inches may be used. Any number of carpenter bee traps 202 and 402 may be installed around the wooden structure 100, depending on, for example, the size of an anticipated infestation, the cost, and the desired frequency of cleaning.

Although the term “longitudinal” is used throughout, meaning in the direction of the longest dimension, longitudinal passages need not necessarily be oriented along the longest axis of a particular trap. The longitudinal passages 206 and 406 may be parallel to each other or oriented at any angle with respect to one another. The longitudinal passages 206 and 406 may be configured perpendicular to the entryways 204 and 404 or at any angle with respect to the entryways 204 and 404. Additionally, the longitudinal passages 206 and 406 may be oriented at an upward angle, or any desired angle, once installed.

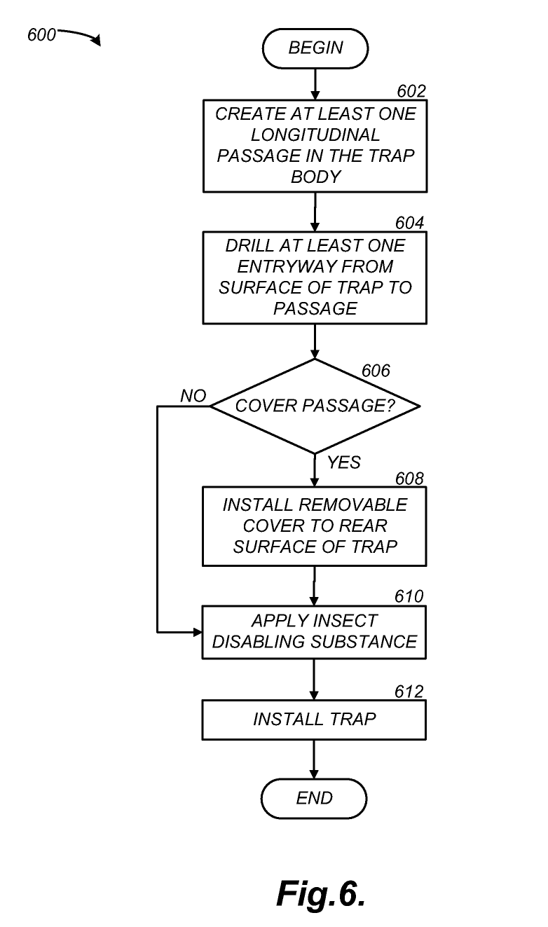

Turning now to FIG. 6, an illustrative routine 600 will be described for creating the carpenter bee trap 202 according to various embodiments presented herein. The routine 600 will be described with respect to the carpenter bee trap 202 shown in FIGS. 2-3C. However, it should be appreciated that the routine 600 is equally applicable to the creation of the carpenter bee trap 402 shown in FIGS. 4-5D. The routine 600 begins at operation 602, where at least one longitudinal passage 206 is created by routing a channel into the rear surface 203 of a trap body, which may be a piece of wood. The routine 600 continues from operation 602 to operation 604, where at least one entryway 204 is created by drilling a hole from the side surface 205 of the trap body to a depth within the trap body in which the entryway intersects the longitudinal passage 206.

From operation 604, the routine 600 continues to operation 606, where a determination is made as to whether the carpenter bee trap 202 will have a cover over the longitudinal passage 206 when the carpenter bee trap 202 is not installed on the wooden structure 100. As mentioned above, the longitudinal passage 206 may be exposed when the carpenter bee trap 202 is not installed, as is shown in FIGS. 3A-3C. Alternatively, the carpenter bee trap 202 may include a cover that is hinged, slidably removed, or otherwise engaged to the rear surface 203 of the trap body. In this alternative embodiment, the cover may provide the mounting surface, which is mechanically attached to the wooden structure 100 when the carpenter bee trap 202 is installed.

If at operation 606, it is determined that a cover is not to be utilized, then the routine 600 proceeds to operation 610 and continues as described below. However, if at operation 606, it is determined that a cover is to be utilized, then the routine 600 proceeds to operation 608, where a removable cover is installed on the rear surface 203 of the carpenter bee trap 202. The routine 600 continues from operation 608 to operation 610, where the insect disabling substance 208 is applied to one or more locations on the longitudinal passage 206. From operation 610, the routine 600 continues to operation 612, where the trap is installed on the wooden structure 100 using the screws 209 or other fasteners and the routine 600 ends.

Although the subject matter presented herein has been described in conjunction with one or more particular embodiments and implementations, it is to be understood that the invention is not necessarily limited to the specific structure, configuration, or functionality described herein. Rather, the specific structure, configuration, and functionality are disclosed as example forms of the invention. The subject matter described above is provided by way of illustration only and should not be construed as limiting. Various modifications and changes may be made to the subject matter described herein without following the example embodiments and applications illustrated and described, and without departing from the true spirit and scope of the present invention.

What is claimed is:

1. A wood-boring insect trap, comprising:
a trap body;
a longitudinal passage within the trap body configured such that the longitudinal passage may be exposed for application of an insect disabling substance on a surface of the longitudinal passage when the wood-boring insect trap is in an uninstalled configuration and concealed when the wood-boring insect trap is in an installed configuration; and
an insect entryway into the trap body configured to intersect the longitudinal passage at a first end of the entryway and exit an exposed surface of the trap body at an opposing second end of the entryway.

2. The wood-boring insect trap of claim 1, wherein the trap body comprises wood.

3. The wood-boring insect trap of claim 1, wherein the insect entryway is one of a plurality of insect entryways, and wherein the first end of each entryway is spaced apart from an adjacent entryway by a distance that allows for a quantity of a disabling substance that is sufficient to disable a targeted wood-boring insect.

4. The wood-boring insect trap of claim 1, wherein configured such that the longitudinal passage may be exposed for application of the insect disabling substance on the surface of the longitudinal passage when the wood-boring insect trap is in the uninstalled configuration and concealed when the wood-boring insect trap is in the installed configuration comprises configured as a channel in a rear surface of the wood-boring insect trap such that the channel is exposed with the wood-boring insect trap is not attached to a structure and is concealed when the rear surface of the wood-boring insect trap abuts the structure.

5. The wood-boring insect trap of claim 1, wherein configured such that the longitudinal passage may be exposed for application of the insect disabling substance on the surface of the longitudinal passage when the wood-boring insect trap is in the uninstalled configuration and concealed when the wood-boring insect trap is in the installed configuration comprises a cover attached to the trap body and configured to expose the longitudinal passage to create the uninstalled configuration and to conceal the longitudinal passage to create the installed configuration.

6. The wood-boring insect trap of claim 1, wherein the longitudinal passage is one of a plurality of parallel longitudinal passages and wherein the insect entryway is one of a plurality of insect entryways intersecting the plurality of parallel longitudinal passages.

7. The wood-boring insect trap of claim 1, further comprising the insect disabling substance disposed on the surface of the longitudinal passage.

8. The wood-boring insect trap of claim 7, wherein the insect disabling substance comprises an insect poison.

9. The wood-boring insect trap of claim 7, wherein the insect disabling substance comprises a glue.

10. The wood-boring insect trap of claim 1, further comprising a mounting surface configured for attachment to a structure to be protected, wherein a longitudinal axis of the insect entryway is coplanar with the mounting surface.

11. The wood-boring insect trap of claim 1, further comprising a mounting surface configured for attachment to a structure to be protected, wherein a longitudinal axis of the insect entryway is perpendicular to the mounting surface.

12. A method for creating a wood-boring insect trap, comprising:
creating a longitudinal passage within a surface of a trap body such that the longitudinal passage is exposed for application of an insect disabling substance on a surface of the longitudinal passage when the wood-boring insect trap is in an uninstalled configuration and concealed when the wood-boring insect trap is in an installed configuration; and
creating an insect entryway in the trap body, wherein the entryway is configured to intersect the longitudinal passage at one end of the entryway and exit an exposed surface of the trap body at an opposing end of the entryway.

13. The method of claim 12, wherein the trap body comprises wood and wherein creating the longitudinal passage within the trap body comprises routing a channel into a rear surface of the trap body.

14. The method of claim 13, wherein the trap body comprises wood and wherein creating the insect entryway comprises drilling an aperture from the exposed surface of the trap body to the longitudinal passage.

15. The method of claim 12, wherein the exposed surface of the trap body comprising the entryway is substantially perpendicular to a mounting surface of the trap body that is configured for attachment to a structure to be protected from wood-boring insects.

16. The method of claim 12, wherein the exposed surface of the trap body comprising the entryway is substantially parallel to a mounting surface of the trap body that is configured for attachment to a structure to be protected from wood-boring insects.

17. The method of claim 12, further comprising applying an insect disabling substance on a surface of the longitudinal passage.

18. A wood-boring insect trap system, comprising:
a trap body;
a longitudinal passage within the trap body configured such that the longitudinal passage may be exposed for application of an insect disabling substance on a surface of the longitudinal passage when the wood-boring insect trap is in an uninstalled configuration and concealed when the wood-boring insect trap is in an installed configuration;
an insect entryway into the trap body configured to intersect the longitudinal passage at a first end of the entryway and exit an exposed surface of the trap body at an opposing second end of the entryway; and
the insect disabling substance applied on the surface of the longitudinal passage.

19. The wood-boring insect trap system of claim 18, wherein when the wood-boring insect trap system is in an installed configuration, the longitudinal passage is enclosed by the trap body on a first side of the longitudinal passage and by a structure to which the wood-boring trap system is installed on a second side of the longitudinal passage.

20. The wood-boring insect trap system of claim 18, wherein the trap body is wood, wherein the longitudinal passage is one of a plurality of longitudinal passages, wherein the insect entryway is one of a plurality of insect entryways, and wherein a longitudinal axis of each of the plurality of insect entryways is substantially perpendicular to a mounting surface of the trap body that is configured for attachment to a structure to be protected from wood-boring insects.
